(19) United States
(12) Patent Application Publication
(10) Pub. No.: US 2025/0392084 A1
(43) Pub. Date: Dec. 25, 2025

(54) LARGE VEHICLE AND BOAT POWER INLET MONITORING DEVICE AND SYSTEM

(71) Applicant: Hughes Autoformers, LLC, Anaheim, CA (US)

(72) Inventor: Patrick Allan Thomas, Yorbo Linda, CA (US)

(21) Appl. No.: 19/312,603

(22) Filed: Aug. 28, 2025

Related U.S. Application Data
(63) Continuation of application No. 18/656,833, filed on May 7, 2024.
Application No. 18/656,833 is a continuation-in-part of application No. 17/453,806, filed on Nov. 5, 2021, now Pat. No. 12,049,146.
Application No. 18/656,833 is a continuation-in-part of application No. 17/326,190, filed on May 20, 2021, now Pat. No. 12,057,696.
(60) Provisional application No. 62/641,150, filed on Mar. 9, 2018.
(60) Provisional application No. 63/156,493, filed on Mar. 4, 2021.

(51) Int. Cl. H01R 13/713; G08B 5/22; G08B 5/38; H01R 13/52; H01R 13/641; H01R 24/70

(52) U.S. Cl. CPC H01R 13/7135; G08B 5/226; G08B 5/38; H01R 13/641; H01R 24/70; H01R 13/5213; H01R 2201/26

(57) ABSTRACT

A power inlet protection and monitoring device includes a power connection port configured to be on a vehicle and configured to have electrical characteristics when accepting power from an external power source, a monitoring module configured to measure electrical characteristics of the power connection port and configured to determine whether the electrical characteristics of the power connection port are in tolerance, wherein when the monitoring module determines that the electrical characteristics of the power connection port are out of tolerance or a fault may present, the monitoring module triggers one or more alarm conditions, and a power conditioner module that includes a surge protector configured to redirect an over voltage or over amperage.

### CROSS-REFERENCE TO RELATED APPLICATIONS

This patent application is a continuation of U.S. patent application Ser. No. 18/656,833, filed on May 7, 2024, entitled “LARGE VEHICLE AND BOAT TOWER INLET MONITORING DEVICE AND SYSTEMS,” which is a continuation-in-part of U.S. patent application Ser. No. 17/453,806, filed on Nov. 5, 2021, entitled “LARGE VEHICLE AND BOAT POWER INLET MONITORING DEVICE AND SYSTEM,” now U.S. Pat. No. 12,049,146, which claims benefit to U.S. Provisional Patent Application No. 63/156,493, filed Mar. 4, 2021, entitled “LARGE VEHICLE AND BOAT POWER INLET MONITORING DEVICE AND SYSTEM,” and a continuation-in-part of U.S. patent application Ser. No. 17/326,190, filed on May 20, 2021, entitled “RECREATIONAL VEHICLE POWER MONITORING AND REPORTING DEVICE AND METHOD,” which is a continuation-in part of U.S. patent application Ser. No. 16/299,144, filed Mar. 12, 2019, entitled “RECREATIONAL VEHICLE POWER MONITOR AND REPORTING DEVICE AND METHOD,” now U.S. Pat. No. 11,128,934, which claims benefit to U.S. Provisional Patent Application No. 62/641,150, filed on Mar. 9, 2018, entitled “RECREATIONAL VEHICLE POWER MONITOR AND REPORTING DEVICE AND METHOD,” and further claims the benefit to U.S. Provisional Patent Application No. 63/499,706, filed on May 2, 2023, entitled “LARGE VEHICLE AND BOAT POWER INLET MONITORING DEVICE AND POWER CONDITIONING SYSTEM,” the entire disclosures of which are incorporated herein by reference.

### BACKGROUND

Large vehicles, such as recreational vehicles (RV) and boats, often have onboard electrical and battery systems that must be externally powered and charged via a power inlet. These power inlets are generally configured to receive a large amount of electricity at a relatively high voltage and amperage.

The power inlets are generally twist-lock connectors. A power cable runs from an RV park pedestal or dock pedestal to the RV or boat, respectively. The power cable is then placed into the power inlet opening, twisted to lock, and sometimes a threaded sealing ring is used to obtain water resistance.

There are several different models of power inlets on the market. However, before the power inlet of the present disclosure, these power inlets did not offer anything other than a secure electrical connection to a boat or RV.

Because many recreational vehicles are mobile, they are used in various locations rather than a single location owned or maintained by the recreational vehicle owner. As a result, some of the power sources connected to the recreational vehicle may provide power of an unknown quality. The recreational vehicle may be damaged when the power quality is poor.

Additionally, because of the high voltage and amperage from a power source to the recreational vehicles, the recreational vehicle may be adversely affected by a poor-quality power source and may cause damage if not quickly noticed.

Thus, there exists a need for owners of recreational vehicles to quickly and easily confirm that the power source that they connect to via the power inlet is of a proper quality by quick visual inspection or to receive notifications when power quality changes while the owner is not in close physical proximity to the vehicle.

### SUMMARY

These, as well as other components, steps, features, objects, benefits, and advantages, will now become clear from a review of the following detailed description of illustrative embodiments, the accompanying drawings, and the claims.

One embodiment as shown and described herein includes a power inlet protection and monitoring device that includes a power connection port configured to be on a vehicle and to accept an external power source, wherein the power connection port has electrical characteristics when accepting power from an external power source, a monitoring module configured to measure electrical characteristics of the power connection port and configured to determine whether the electrical characteristics of the power connection port are in tolerance, wherein the monitoring module triggers one or more alarm conditions when the monitoring module determines that the electrical characteristics of the power connection port are out of tolerance or a fault is present, and a power conditioner module including a surge protector configured to redirect an over voltage or over amperage.

Another embodiment as shown and described herein may further or alternatively include a power inlet protection and monitoring device for a recreational vehicle that includes an electrical input port configured to be coupled to an electrical power source via at least one positive wire, a neutral wire and a ground wire, an electrical output connection configured to transmit electrical power to the recreational vehicle, a surge protector electrically coupled to the electrical input port and to the electrical output connection, and a power monitor including at least one sensor, wherein the power monitor is configured to receive information gathered by the at least one sensor, wherein the information includes the status of a voltage carried on the ground wire, wherein power monitoring and reporting device is configured to cut off an electrical connection between the electrical input port and the electrical output connection based on the status of the voltage carried on the ground wire to prevent a damaging electrical event in the recreational vehicle, and wherein the power inlet protection and monitoring device is configured to communicate power data to a user based on the information.

Yet another embodiment as shown and described herein may further or alternatively include a power inlet protection and monitoring device for a recreational vehicle, that includes an electrical input port configured to be coupled to an external power source via at least one voltage line, a neutral line and a ground line, wherein the electrical input port has electrical characteristics when accepting power from an external power source, an electrical output connection configured to transmit electrical power to the recreational vehicle, a power monitor configured to measure electrical characteristics of the electrical output connection and configured to determine whether the electrical characteristics of the electrical output connection are in tolerance, wherein when the power monitor determines that the electrical characteristics of the electrical output connection are out of tolerance or a fault is present the monitoring module triggers one or more alarm conditions, wherein the power monitor comprises one or more sensors configured monitor for a positive voltage carried on the ground line and wherein the electrical characteristics measured by the power monitor includes the positive voltage carried on the ground line, a power conditioner including a surge protector configured to redirect a surge in voltage and amperage, wherein when the power monitor triggers the alarm condition the power inlet protection and monitoring device cuts off the electrical connection of the ground line between the electrical input port and the electrical output connection, and a communicator configured to transmit power data to a remote device based on the electrical characteristics measured by the power monitor.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a schematic front elevation view of one embodiment of a power inlet monitoring device;

FIG. 2 is a perspective view of a power line;

FIG. 3 is a block diagram of one embodiment of a power inlet monitoring device connected to a power supply and a remote device;

FIG. 4A is a perspective view of one embodiment of a power inlet monitoring device;

FIG. 4B is a side elevation view of the power inlet monitoring device of FIG. 3A;

FIG. 5A is a perspective view of an alternative embodiment of a power inlet monitoring device;

FIG. 5B is a side elevation view of the power inlet monitoring device of FIG. 4A;

FIG. 6 is a side elevation view of an installation of a power inlet monitoring device;

FIG. 7A is an illustration of a normal indication on a power inlet monitoring device;

FIG. 7B is an illustration of a missing ground alarm indication on a power inlet monitoring device;

FIG. 7C is an illustration of a missing neutral alarm indication on a power inlet monitoring device;

FIG. 7D is an illustration of a missing L1 alarm indication on a power inlet monitoring device;

FIG. 7E is an illustration of a missing L2 alarm indication on a power inlet monitoring device;

FIG. 7F is an illustration of an L1 and neutral reversed alarm indication on a power inlet monitoring device;

FIG. 7G is an illustration of an L2 and neutral reversed alarm indication on a power inlet monitoring device;

FIG. 7H is an illustration of an L1 or L2 and ground-reversed alarm indication on a power inlet monitoring device;

FIG. 7I is an illustration of a voltage alarm indication on a power inlet monitoring device;

FIG. 7J is an illustration of an over-amperage alarm indication on a power inlet monitoring device;

FIG. 7K is an illustration of a surge protection alarm indication on a power inlet monitoring device;

FIG. 8 is a schematic view of a removable power conditioning module;

FIG. 9 is a schematic view of one embodiment of a power inlet monitoring device used in a recreational vehicle with remote reporting;

FIG. 10 is a schematic view of one embodiment of a power inlet monitoring device used in a recreational vehicle;

FIG. 11 is an illustration showing an installation interface screen of a remote user device associated with a power inlet monitoring device;

FIG. 12 is an illustration showing a notification setup screen of a remote user device associated with a power inlet monitoring device;

FIG. 13 is an illustration showing a 30 AMP data screen of a remote user device associated with a power inlet monitoring device; and

FIG. 14 is an illustration showing a 50 AMP data screen of a remote user device associated with a power inlet monitoring device.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Embodiments of the systems and methods may be described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

As used herein: the terms “amperage,” “electrical current,” and “current” refer to the movement of electrons through an electrical conductor; the terms “central processing unit (“CPU”),” “microprocessor,” or “microcontrollers” refers to a complex set of electronic circuitries that interprets, processes, and executes instructions; the term “communication bus,” “control bus,” “bus lines,” or “bus” refers to a system that transfers data between components inside an electronic device and may communicate with an external electronic device(s); the term “electricity” refers to a form of energy resulting from the existence of charged particles such as electrons; the term “module” refers to an assembly that contains several electronic components to perform various electrical functions; the term “National Electrical Manufacturers Association” or “NEMA” refers to standards for electrical enclosures in North America; the term “parameter” refers to a numerical or other measurable factor that defines a system's characteristics; the term “pole” or “prong” refers to the electrical connection that may be inserted into the holes of an outlet or receptacle to establish the electrical connection between a device and a power source; the term “power” refers to the rate at which electrical energy is transferred and is typically measured in watts; the term “power cable” refers to a cable that transmits electrical power from a power source to a device; the term “power quality” refers to the measure of how well the voltage, frequency, and waveform of a power supply system matches established specifications; the term “reverse polarity” or “polarity issue” refers to a condition where the wires of an outlet are connected in reverse; the term “tolerance” refers to the amount of variation in a parameter that is acceptable for an object to still function; and the term “wireless communications” refers to the transfer of information between two or more points without the use of an electrical conductor, optical fiber, or other continuous guided medium for the transfer

The present disclosure's power inlet protection and monitoring device may include a power connection port, a monitoring module, a power condition module, indicator lights, and a communication module. One or more of the modules may be removable and replaceable. The power inlet protection and monitoring device may measure electrical characteristics, determine electrical faults, determine status, determine alarms, and provide local and or remote indications of electrical status. The power inlet protection and monitoring device may further electrically isolate a vehicle from an external power source.

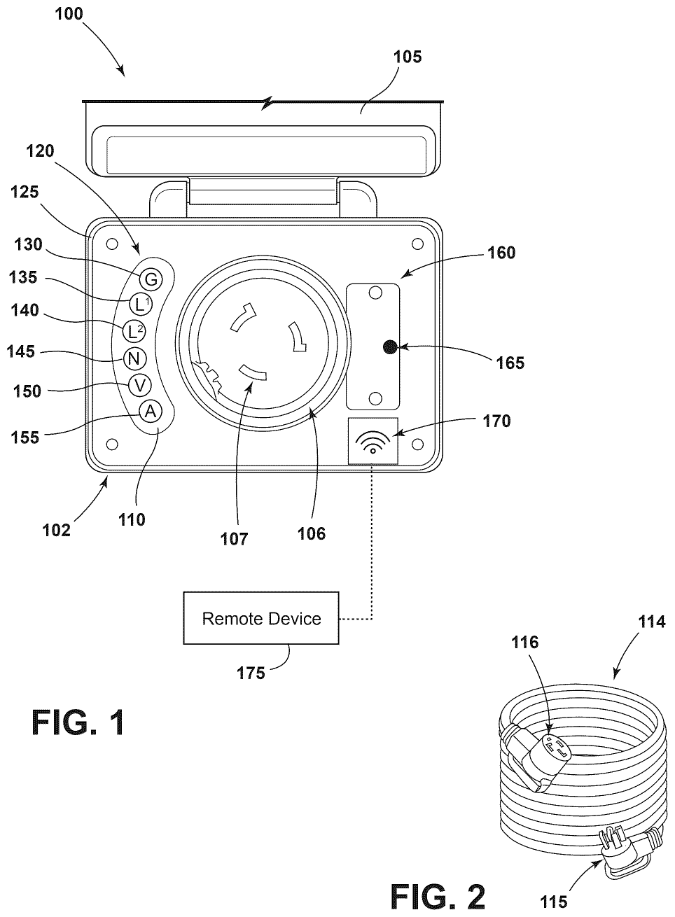

FIG. 1 is a schematic front elevation view of one embodiment of a power inlet monitoring device that may comprise a base 102, a cover 105, a power connection port 106, one or more electrical prongs 107, one or more indicator lights 110, a monitor module 120, a general status indicator 125, a power conditioner module 160, and a surge indicator 165.

In one embodiment the power inlet monitoring device 100 may include a communication module 170. The power inlet monitoring device 100 may be adapted to be connected to a power line 114 such as that illustrated in FIG. 2, where the power line is configured to releasably couple to the power connection port 106. The power line 114 may be configured to conduct a maximum of 20 amperes (“A” or “AMPs”), 30 AMPs, or 50 AMPs and may include a male plug 115 configured to releasably couple to the power connection port 106 and a female plug 116 configured to couple to an external power source as described below.

The base 102 may preferably be an electronic enclosure designed to protect, contain, and enclose the electronic components of power inlet monitoring device 100, such as but not limited to switches, relays, printed circuit boards (PCB), integrated circuits, power supplies, microprocessors, and the like. The base 102 may also include the general status indicator 125 that may illuminate white or green to represent that all parameters are in tolerance or may illuminate or flash red, indicating one or more parameters are out of tolerance or a fault may be present. The base 102 may comprise rigid plastics such as but not limited to polycarbonate, acrylonitrile butadiene styrene, PC+ABS Blend, polybutylene terephthalate, or metals such as steel, stainless steel, or aluminum, or any combination thereof.

In one embodiment, the cover 105 may provide a waterproof or water-resistant seal over the power connection port 106, the general status indicator 125, the surge indicator 165, and the one or more indicator lights 110. The cover 105 may be adapted to prevent dust, water, and other particles from entering into and disrupting the function of power inlet monitoring device 100. The cover 105 may also be adapted to prevent unwanted access to the power inlet monitoring device 100. For example, the cover 105 may include a locking mechanism (not shown) in order to prevent third parties from having unauthorized access to the power inlet monitoring device 100. The cover 105 may preferably be an electronic cover designed to protect and enclose the power inlet monitoring device 100. The cover 105 may comprise rigid plastics such as but not limited to polycarbonate, acrylonitrile butadiene styrene, PC+ABS Blend, polybutylene terephthalate, or metals such as steel, stainless steel, or aluminum, or any combination thereof.

The combination of the base 102 and the cover 105 may create a complete electrical enclosure that protects the power inlet monitoring device 100 electrical or electronic components and prevents electrical shock to a user. The combination of the base 102 and the cover 105 may preferably be one of many standard configurations pursuant to the National Electrical Manufacturers Association (NEMA).

The power connection port 106 may be a 30 ampere (“AMP”) or 50 AMP twist lock inlet. The power connection port 106 may include one or more of the electrical prongs 107, where a 30 AMP three (3) prong is shown in FIG. 1. The power connection port 106 may comprise ground, neutral, and 120-volt prongs also referred to as L1 voltage line, configured to matingly engage the female plug 116 of power line 114. A 50 AMP four (4) prong power connection port (not shown) may comprise ground, neutral, and two 120-volt prongs, also referred to as L1 and L2 voltage lines configured to matingly engage power line 114. The power connection port 106 may be preferably one of many standard configurations pursuant to the National Electrical Manufacturers Association (NEMA).

The power line 114 may be an RV power cord or shore power connection and may preferably be configured to deliver power to a large vehicle through the power inlet monitoring device 100. As discussed above, the power line 114 may include the female plug 116 and the male plug 115 where the female plug 116 may be plugged into power connection port 106. The power line 114 may be configured to supply 30 AMPs or 50 AMPs to power inlet monitoring device 100. In a preferred embodiment, the power line 114 may twist and lock into place on the power connection port 106. For example, the power line 114 may comprise a connector such that the power line 114 may engage with power connection port 106, and a user of the power inlet monitoring device 100 may twist female plug 116 to lock the connector into place in the power connection port 106 such that the female plug 116 may be prevented from accidentally disconnecting. In some embodiments, the power connection port 106 may comprise different locking engagement mechanisms, or in some embodiments, no locking engagement mechanisms.

The monitoring module 120 may be a removable and replaceable unit within base 102. The monitoring module 120 may include one or more indicator lights 110. For example, the one or more indicator lights 110 (FIG. 1) may include but are not limited to a ground indicator 130, a L1 indicator 135, a L2 indicator 140, a neutral indicator 145, a voltage indicator 150, and an amperage indicator 155.

In one embodiment, if all components and parameters of the power connection port 106 are operating within tolerances and no faults are detected, each of the indicator lights 110, the ground indicator 130, the L1 indicator 135, the L2 indicator 140, the neutral indicator 145, the voltage indicator 150, and the amperage indicator 155 may be green, white, or another preferred color. In one embodiment, if the monitoring module 120 detects an out-of-tolerance condition, a fault, or other issues with the specific electrical power or connections, such as power on, open neutral, open ground, missing L1 voltage, missing L2 voltage, L1 and neutral reversed, L2 and neutral reversed, no power, and voltage on ground may cause the corresponding indicator light a different color, such as red, yellow, or another preferred color. In this way, the indicator lights 110, the ground indicator 130, the L1 indicator 135, the L2 indicator 140, the neutral indicator 145, the voltage indicator 150, and the amperage indicator 155 may comprise one or more color states corresponding to operating within expected parameters or operating outside expected parameters. The indicator lights 110, the ground indicator 130, the L1 indicator 135, the L2 indicator 140, the neutral indicator 145, the voltage indicator 150, and the amperage indicator 155 may also illuminate at varying intensities corresponding to the degree of deviation of the power flow from expected parameters. In one embodiment, the general status indicator light 125 may be a predetermined color, such as green or white, when there are no detected issues with the power flow or may be a different color, such as red or yellow, if there are any detected issues with the power flow. It is understood that the indicator lights 110, the ground indicator 130, the L1 indicator 135, the L2 indicator 140, the neutral indicator 145, the voltage indicator 150, and the amperage indicator 155 may use substantially any color, with a preference toward consistency of color use. The general status indicator light 125 may be visible even when the cover 105 may be in a closed position, such as by being located around a perimeter of the base 102. The indicator lights 110, the ground indicator 130, the L1 indicator 135, the L2 indicator 140, the neutral indicator 145, the voltage indicator 150, and the amperage indicator 155 may be covered and not visible until the cover may be open 105. In an alternate embodiment, the cover 105 may be configured only to cover the power connection port 106, which may leave the indicator lights 110, the ground indicator 130, the L1 indicator 135, the L2 indicator 140, the neutral indicator 145, the voltage indicator 150, and the amperage indicator 155 visible.

In some embodiments, the general status indicator 125 may be a light source that illuminates different colors via a “Halo” effect depending on the condition of the power flow being monitored by a monitoring module of the power inlet monitoring device 100.

In some embodiments, the general status indicator 125 may also function as a safety light source to provide light. For example, the illumination from the general status indicator 125 may allow a user of the power inlet monitoring device 100 to safely unlock the power line from the power inlet monitoring device 100 by sufficiently illuminating the area surrounding the power inlet monitoring device 100.

In some embodiments, the monitoring module 120 may monitor voltage and amperage through the power connection port 106, in addition to detecting the reverse polarity of L1, L2, and neutral, open ground, and open neutral conditions. In some embodiments, the monitoring module 120 may be configured to monitor various electric characteristics such as impedance, resistance, inductance, capacitance, instant power, and power over time. The monitoring module 120 may be further configured to determine other power flow characteristics based on the monitored characteristics.

In one embodiment, the monitoring module 120 may monitor the communication module 170, the power conditioner module 160, the ground, line 1 (“L1”), line 2 (“L2), neutral (“N”), of external power source to ensure proper operation. The monitoring module 120 may monitor and/or measure parameters and conditions such as, but not limited to, frequency, voltage, amperage, ground voltage, ground impedence, ground fault, open neutral faults, miscellaneous power connection port 106 faults, monitor both the load side and the supply side as well as current in both directions, and measure the presence of grounding on the supply side and the load side. In one embodiment, the monitoring module 120 may be configured to continuously monitor the power frequency, voltage, and amperage through power connection port 106 to determine specific qualities of the measure parameters.

The power conditioner module 160 may be a removable and replaceable unit within base 102. The power conditioner module 160 may include one or more indicator lights, such as a surge indicator 165. In one embodiment, if all components of the power conditioner module 160 are operating as expected and no electrical faults have occurred, the surge indicator 165 may illuminate with a green, white, or another preferred color. In one embodiment, if the power conditioner module 160 experiences a fault condition or other issue with the incoming voltage or amperage, such as a spike in voltage or amperage, power conditioner module 160 may cause the surge indicator 165 to light a different color, such as red, yellow, or another preferred color. In some embodiments, the power conditioner module 160 may function as a surge protector or surge protection module that partially or entirely prevents an over voltage or over amperage from reaching the associated vehicle. When functioning as a surge protection module, the power conditioner module 160 may serve as a high potential or high voltage (hipot) bypass device. The various configurations of the power inlet protection and monitoring device as described herein allow the entire assembly of a vehicle, including the connection of various appliances and components, without the inclusion of the surge protection module until after the vehicle assembly process has been completed.

The remote device 175 may be a mobile phone, a tablet, a computer, or a combination thereof and may receive data wirelessly from power inlet monitoring device 100. The remote device 175 may communicate through near field communication technology, Wi-Fi, Bluetooth, cellular service, or any other wireless communication protocol directly or through internet and telecommunication systems.

The communication module 170 may be a removable and replaceable unit within the base 102. In one embodiment, the communication module 170 may transmit wireless signals and information to the remote device 175. In some embodiments, the signals transmitted to the remote device 175 may be based on data collected by the monitor module 120. In some embodiments, the signals transmitted to the remote device 175 may be based on issues detected or determined by the monitor module 120. In other embodiments, the communication module 170 may be configured to transmit signals to the remote device 175 to confirm the normal operation of the power flow. In other embodiments, the communication module 170 may be configured to transmit signals to the remote device 175 to display the monitoring continuously.

The communication module 170 may be in electronic communication (wired or wireless) with the monitor module 120, such that information regarding the specific details of the electrical parameters and fault status may be relayed from the monitoring module 120 to the communication module 170, and the specific details of the electrical parameters and fault status may then be transmitted to the remote device 175 through near field communication technology, Wi-Fi, Bluetooth, cellular service, or any other wireless communication protocol directly or through internet and telecommunication systems. In one embodiment, the remote device 175 may be configured to receive from the communication module 170 the specific details of the power flow and process the information as necessary or desired. The remote device 175 may be configured to alert the user if the specific details of the power flow indicate that there are any problems with the power flow. In some embodiments, the user may be able to customize when the remote device 175 alerts the user, such as by adjusting the settings to alert the user when the power flow deviates a preset amount from what may be expected.

In alternate embodiments, the communication module 170 may be replaced or supplemented with a wired communication module (not shown). In one embodiment, the wired communication module may communicate with the onboard vehicle system.

The power inlet monitoring device 100 may preferably be configured for use with large vehicles, such as recreational vehicles and boats. In one embodiment, the power inlet monitoring device 100 may be adapted to receive the large three-prong heavy-duty 30-amp 120/125-volt (or 240/250 volt) plug associated with recreational vehicles and boats. In an alternate embodiment, the power inlet monitoring device 100 may be adapted to receive the large four-prong heavy-duty 50 AMP 120/125-volt (or 240/250 volt) plug associated with recreational vehicles and boats. In some embodiments, the power inlet monitoring device 100 may include attachments and adapters such that different plugs of varying voltages, amperages, and connectors may be used.

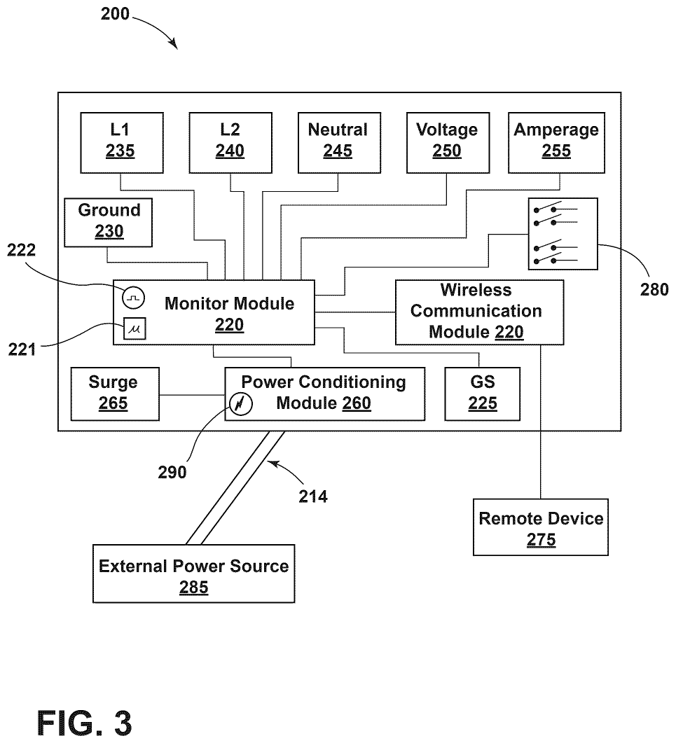

FIG. 3 is a block diagram of one embodiment of a power inlet monitoring device connected to an external power supply 285 and a remote device 275. The power inlet monitoring device 200 may comprise monitor module 220, a general status indicator 225, a communication module 270, a power conditioner module 260, one or more electrical connections 214, and electrical disconnects 280.

The monitor module 220 may comprise one or more microcontrollers 221, one or more sensors 222, one or more indicator lights such as but not limited to a ground indicator 230, an L1 indicator 235, an L2 indicator 240, a neutral indicator 245, a voltage indicator 250, and an amperage indicator 255. The one or more sensors 222 may comprise frequency, voltage, amperage, magnetic, impedance, ground status, neutral status, and resistance sensors that may directly or indirectly measure the electrical characteristics of the one or more electrical connections 214. The electrical characteristics include but are not limited to frequency, voltage, amperage, magnetic fields, impedance, and resistance. At the same time, the power inlet monitoring device 200 may be connected to the external power source 285. The monitor module 220 may utilize the one or more microcontrollers 221 to monitor the one or more sensors 222. The one or more microcontrollers 221 may process the measurements or information from the one or more sensors 222. The processed measurements or information may provide the one or more microcontrollers 221 with various parameters of the one or more electrical connections 214. The one or more microcontrollers 221 may store tolerances to determine whether or not an alarm condition or fault may be present at or within the one or more electrical connections 214. The alarm conditions may include but are not limited to an out of tolerance condition such as low voltage, high voltage, high amperage, open ground, open neutral, or reverse polarity. The one or more microcontrollers 221 may determine electrical faults such as reverse polarity, open ground, and open neutral conditions. The one or more microcontrollers 221 may enable real-time monitoring of power performance data when aspects of the external power source 285 deviate from expected parameters or are problematic in some other way. Such monitoring may be visualized by the illumination of one or more of the ground indicator 230, the L1 indicator 235, the L2 indicator 240, the neutral indicator 245, the voltage indicator 250, and the amperage indicator 255

The one or more microcontrollers 221 may have one or more outputs that electrically control the illumination, color, or function of the general status indicator 225, the ground indicator 230, the L1 indicator 235, the L2 240, the neutral indicator 245, the voltage indicator 250, the amperage indicator 255, and the electrical disconnect 280. The one or more microcontrollers 221 may electrically disconnect the electrical connections 214 between the power inlet monitoring device 200 and the external power source 285, which may completely isolate the associated vehicle from the external power source 285.

The one or more microcontrollers 221 may process data, store data, output results, transmit commands to components or modules, coordinate control activity, connect input or output, and/or disconnect input or output.

The communication module 270 may be in electronic communication (wired or wireless) with the monitor module 220, such that information regarding the specific details of the electrical parameters and fault status may be relayed from the monitor module 220 to the communication module 270, and the specific details of the electrical parameters and fault status may then be transmitted to the remote device 275 through near field communication technology, Wi-Fi, Bluetooth, cellular service, or any other wireless communication protocol directly or through internet and telecommunication systems. In one embodiment, the remote device 275 may be configured to receive the specific details of the power flow from the communication module 270 and process the information as necessary or desired. The remote device 275 may be configured to alert the user if the specific details of the power flow indicate that there are any problems with the power flow. In some embodiments, the user may be able to customize when the remote device 275 alerts the user, such as by adjusting the settings to alert the user when the power flow deviates a preset amount from what may be expected.

The power conditioner module 260 may protect against voltage fluctuations, electrical noise, amperage fluctuations, or other power disturbances and may increase the longevity of connected components. The power conditioner module 260 may include a surge protection device 290 and the surge indicator 265. The power conditioner module 260 may be in electronic communication (wired or wireless) with the monitor module 220, such that information regarding the specific details of voltage fluctuations, electrical noise, amperage fluctuations, or other power disturbances, and the surge indicator 265 status may be relayed from the monitor module 220 to the communication module 270 and a user.

The one or more electrical connections 214 may comprise ground, neutral, L1, and L2 between the external power source 285 and the power inlet monitoring device 200. The one or more electrical connections 214 may be electrically connected and disconnected by the electrical disconnects 280. The one or more microcontrollers 221 may control the function of the electrical disconnects 280 based on an alarm or fault condition. The one or more microcontrollers 221 may determine that all parameters are in tolerance and maintain the electrical connection between the power inlet monitoring device 100 and the external power source 285. The one or more microcontrollers 221 may determine that one or more parameters are in alarm, or a fault may be present and disconnect the electrical connection between the power inlet monitoring device 100 and the external power source 285. The one or more microcontrollers 221 may determine that one or more parameters are in alarm but maintain the electrical connection between the power inlet monitoring device 100 and the external power source 285.

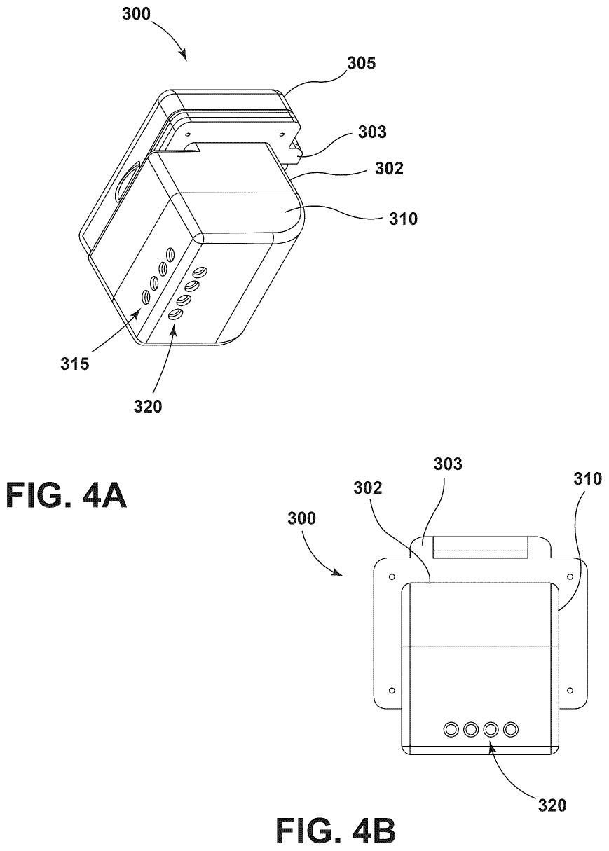

FIG. 4A is a perspective view and FIG. 4B is a rear elevation view of one embodiment of a power inlet monitoring device 300. In the illustrated example, the power inlet monitoring device 300 may include a base 302, a cover 305, a rear enclosure 310, bottom vehicle connections 315, and rear vehicle connections 320. One embodiment of the base 302 may include a lip 303 that may allow the power inlet monitoring device 300 to be installed against a vehicle and the rear enclosure 310 of power inlet monitoring device 300 to be installed internally to a vehicle. The configuration also allows the power inlet monitoring device 300 to be utilized with walls of various thicknesses.

An electrical system of an associated vehicle may be connected to the power inlet monitoring device 300 utilizing either the bottom enclosure connections 315 or the rear vehicle connections 320 depending upon the configuration of the vehicle. The bottom enclosure connections 315 and the rear vehicle connections 320 may allow a vehicle electrical connection to be screwed, clamped, or electrically secured by various configurations and arrangements that may allow electrical amperage to flow into the vehicle's electrical system.

The rear enclosure 310 may be electrically isolated from any electrical connections. The rear enclosure 310 may comprise rigid plastics such as but not limited to polycarbonate, acrylonitrile butadiene styrene, PC+ABS Blend, and polybutylene terephthalate or metals such as steel, stainless steel, aluminum, or any combination thereof.

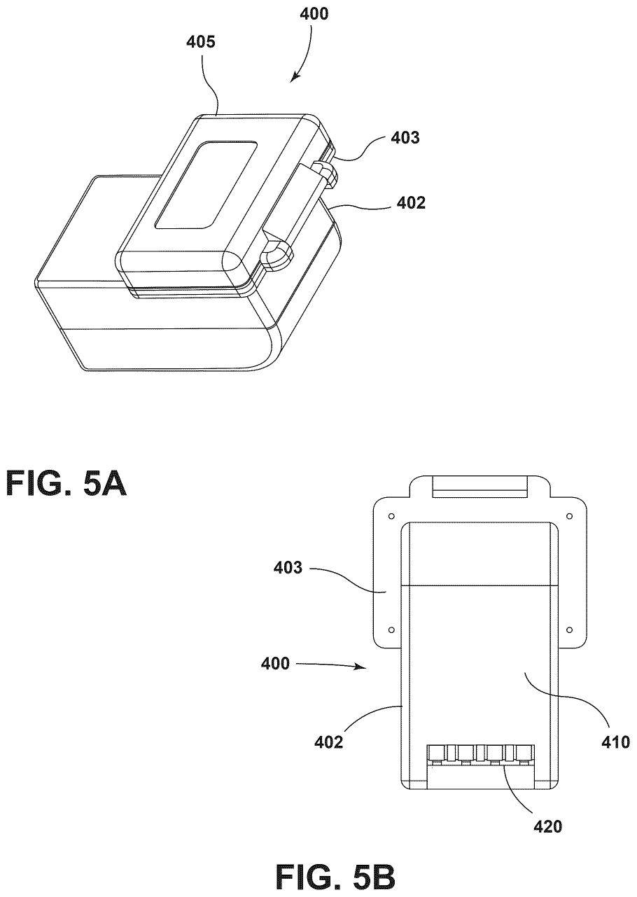

FIG. 5A is a perspective view and FIG. 5B is a rear elevation view of an alternative embodiment of the power inlet monitoring device 400. In the illustrated example, the power inlet monitoring device 400 may include a base 402, a lip 403, a cover 405, a rear enclosure 410, and rear vehicle connections 420. One embodiment of base 402 may include the lip 403 that may allow the power inlet monitoring device 400 to be installed against the associated vehicle and the rear enclosure 410 of power inlet monitoring device 400 to be installed internally to the vehicle.

The electrical system of the vehicle may be connected to power inlet monitoring device 400 utilizing the rear vehicle connections 420. The rear vehicle connections 420 may allow a vehicle electrical connection to be screwed, clamped, or electrically secured by various configurations and arrangements that may allow electrical amperage to flow into the vehicle's electrical system.

The rear enclosure 410 may be electrically isolated from any electrical connections. The rear enclosure 410 may comprise rigid plastics such as but not limited to polycarbonate, acrylonitrile butadiene styrene, PC+ABS Blend, and polybutylene terephthalate or metals such as steel, stainless steel, aluminum, or any combination thereof.

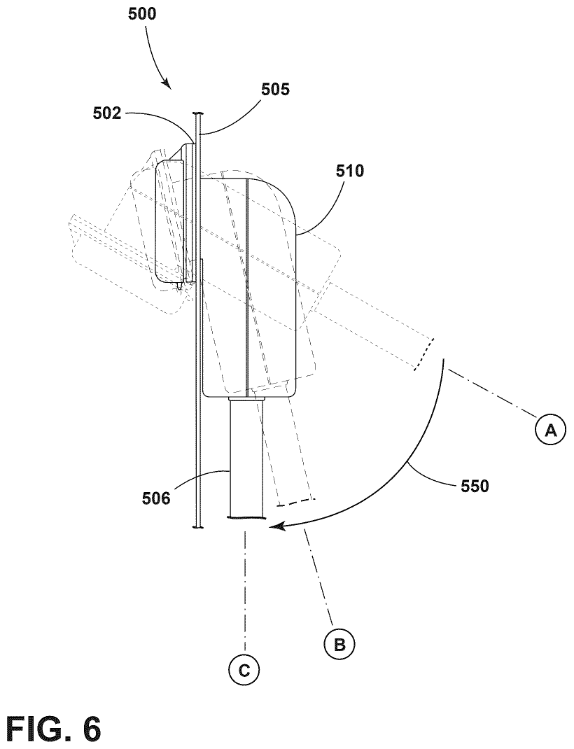

FIG. 6 is a side elevation view illustrating the installation of a power inlet monitoring device. In the illustrated example, the rear enclosure 510 of the base 502 of the power inlet monitoring device 500 may be inserted into the vehicle chassis or sidewall 505. As the power inlet monitoring device 500 is inserted into the vehicle chassis 505 the rear enclosure 510 may rotate about an arc 550 between a first position A through a second position B before the base 502 rests flush against the vehicle chassis 505 in a third position C. The power inlet monitoring device 500 may connect to the vehicle power connection 506 to allow electrical flow into the vehicle.

In some embodiments, the power inlet monitoring device 500 may be mounted on a previously existing power inlet of the vehicle. In other embodiments, the power inlet monitoring device 500 may replace a previously existing power inlet of the vehicle.

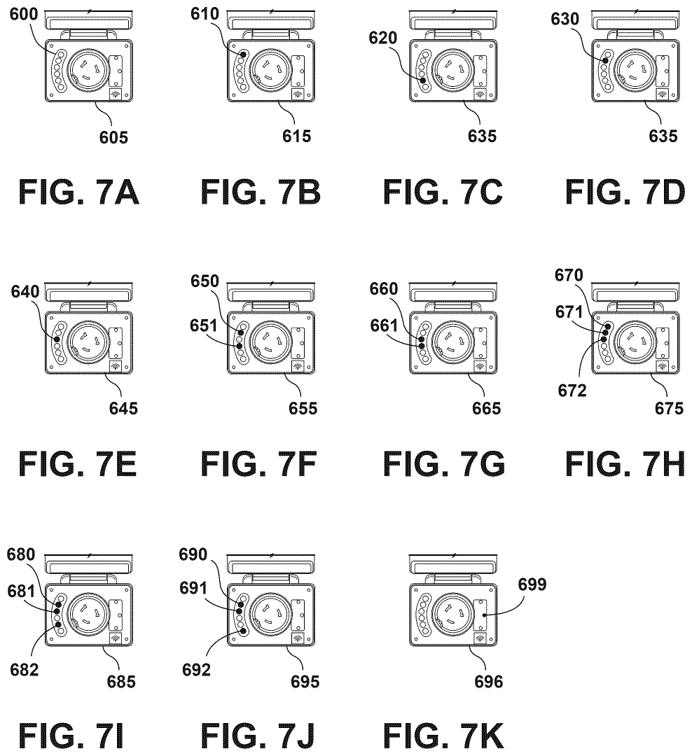

FIGS. 7A-7K illustrate various status indicator outputs and configurations that depend on and are generated as a result of states of the power inlet monitoring devices as shown and described herein. FIG. 6A is an illustration of a normal indication on a power inlet monitoring device. The power inlet monitoring device may illuminate while operating in tolerance, indicating no alarms or faults detected, as shown in FIG. 7A, the general status indicator 600 may be illuminated white, green, or any preferred color to show a normal indication and indicator lights 605 may not be illuminated. In an alternate embodiment, one or more the indicator lights 605 may be illuminated white, green, or any preferred color to show a normal indication.

FIG. 7B is an illustration of a missing ground alarm indication on a power inlet monitoring device. The power inlet monitoring device may illuminate to indicate an out-of-tolerance, alarm condition, or fault on the ground electrical connection, as shown in FIG. 6B, the general status indicator 615 and the ground indicator 610 may be illuminated red or any preferred color to show an out-of-tolerance or alarm indication. Such alarm or fault indication may be but should not be limited to an open ground, missing ground, ground loop, or voltage on the ground.

FIG. 7C is an illustration of a missing neutral alarm indication on a power inlet monitoring device. The power inlet monitoring device may illuminate to indicate an out-of-tolerance, alarm condition, or fault on the neutral electrical connection, as shown in FIG. 6C, the general status indicator 625 and the neutral indicator 620 may be illuminated red or any preferred color to show an out of tolerance or alarm indication. Such alarm or fault indication may be but should not be limited to an open neutral, missing neutral, or a voltage on neutral.

FIG. 7D is an illustration of a missing L1 alarm indication on a power inlet monitoring device. The power inlet monitoring device may illuminate to indicate a missing L1 fault on the L1 electrical connection, as shown in FIG. 6D, the general status indicator 635 and the L1 indicator 630 may be illuminated red or any preferred color to show an out-of-tolerance or alarm indication.

FIG. 7E is an illustration of a missing L2 alarm indication on a power inlet monitoring device. The power inlet monitoring device may illuminate to indicate a missing L2 fault on the L2 electrical connection, as shown in FIG. 6E, the general status indicator 645 and the L2 indicator 640 may be illuminated red or any preferred color to show an out-of-tolerance or alarm indication.

FIG. 7F is an illustration of an L1 and neutral reversed alarm indication on a power inlet monitoring device. The power inlet monitoring device may illuminate to indicate a reverse polarity fault of L1 and neutral as shown in FIG. 6F, the general status indicator 655, the L1 indicator 650, and the neutral indicator 651 may be illuminated red or any preferred color to show the fault.

FIG. 7G is an illustration of an L2 and neutral reversed alarm indication on a power inlet monitoring device. The power inlet monitoring device may illuminate to indicate a reverse polarity fault of L2 and neutral as shown in FIG. 6G, the general status indicator 665, the L1 indicator 660, and the neutral indicator 661 may be illuminated red or any preferred color to show the fault.

FIG. 7H is an illustration of an L1 or L2 and ground-reversed alarm indication on a power inlet monitoring device. The power inlet monitoring device may illuminate to indicate a reverse polarity fault with the ground and L1 or L2 fault as shown in FIG. 6H, the general status indicator 675, the ground indicator 670, the L1 indicator 671, and the L2 indicator 672 may be illuminated red or any preferred color to show the fault.

FIG. 7I is an illustration of a voltage alarm indication on a power inlet monitoring device. The power inlet monitoring device may illuminate to indicate a voltage out of tolerance or fault with L1 or L2, as shown in FIG. 6I, the general status indicator 685, the L1 indicator 680, the L2 indicator 681, and the voltage indicator 682 may be illuminated red or any preferred color to show the fault. Such alarm or fault indication may be but should not be limited to high, low voltage, or missing voltage.

FIG. 7J is an illustration of an over-amperage alarm indication on a power inlet monitoring device. The power inlet monitoring device may illuminate to indicate an amperage out of tolerance or fault with L1 or L2 as shown in FIG. 6J, the general status indicator 695, the L1 indicator 690, the L2 indicator 691, and the amperage indicator 692 may be illuminated red or any preferred color to show the fault. Such alarm or fault indication may be but should not be limited to amperage high or amperage low.

FIG. 7K is an illustration of a surge protection alarm indication on a power inlet monitoring device. The power inlet monitoring device may illuminate to indicate a surge protection fault, as shown in FIG. 6K, the general status indicator 696, and the surge indicator 699 may be illuminated red or any preferred color to show the fault.

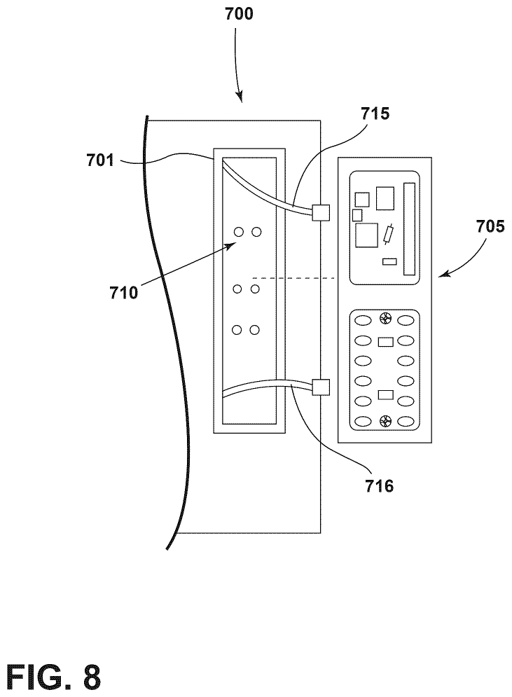

FIG. 8 is an embodiment of a power inlet monitoring devices 700 that includes a removable and replaceable power conditioner module 705. In the illustrated example, the power conditioner module 705 may be removed and installed into power conditioning receptacle 701. Power conditioner receptacle 701 may have wired electrical connections 715 or one or more circuit board connections 710 configured to allow a user to replace a failed, faulty, or damaged power conditioner module 705 with a replacement power conditioner module 705.

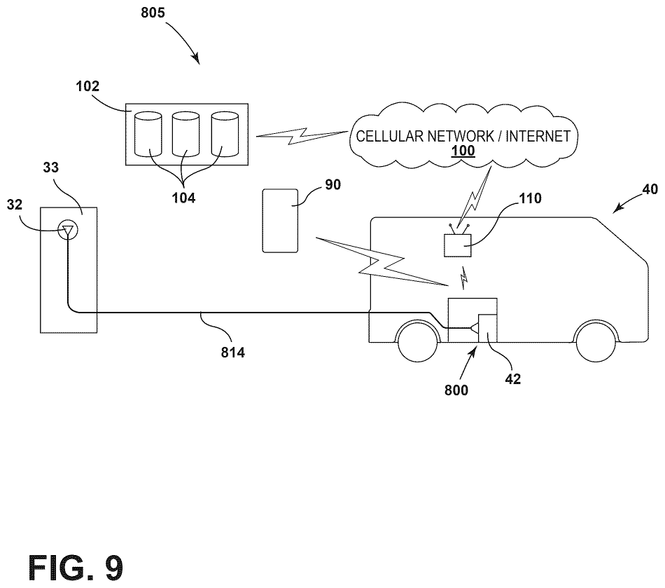

FIG. 9 is a schematic view of another embodiment of a power inlet monitoring device used in a recreational vehicle utilized within in a remote reporting. In the illustrated example, the remote reporting 805 may include the power inlet monitoring device 800, a wireless communication module 42, a reporting device 90, an external power source or supply 33, a male plug 32, a power line 814, a cellular network 100, a local network 110, a web-based computer system 102, and a database 104.

In one embodiment, the power inlet monitoring device 800 may be adapted to include a cellular communications module such as the wireless communications module 42. In the illustrated example, the wireless communications module 42 may be configured to connect to a cellular network such as cellular network 100. Alternatively, the wireless communications module 42 may be configured to connect to a local network 110, which may be an internet communications network. It will be appreciated that the wireless communications module 42 may have many different methods of connecting wirelessly to the user device 90.

In some embodiments, the power inlet monitoring device 800 may further comprise a cellular data card or embedded cellular gateway. The cellular data card or embedded cellular gateway may be provided within the power inlet monitoring device 800 and configured to enable the power inlet monitoring device 800 to connect to a cellular network, such as the cellular network 100. In some embodiments, the power inlet monitoring device 800 may connect to the internet through the cellular network 100.

In some embodiments, the power inlet monitoring device 800 may communicate with the user device 90 via the cellular network 100 and/or the internet rather than through Bluetooth.

In some embodiments, the power inlet monitoring device 800 may be used with software installed on the user device 90. For example, the power inlet monitoring device 800 may send notifications to the user device 90 when power supply aspects fall outside acceptable ranges via text messages over the cellular network 100 or via email notifications from communications through the local network 110 internet connection. The user device 90 may be configured to access a web-based service that may display detailed monitoring data for one or more of the power inlet monitoring devices 800. The web-based service may maintain a computer system 102 having one or more databases 104 that may store data and analysis results generated by one or more of the power inlet monitoring devices 800 and may also perform calculations based on the stored data and analysis results.

In some embodiments, power supply data may be stored in a memory associated with the user device 90, and data storage and processing may be performed on the user device 90.

In some embodiments, the power supply data may be uploaded to the cloud or a host network, where the power supply data may be stored remotely from both the power inlet monitoring device 800 and the linked user device 90.

In some embodiments, power data may be combined or linked with additional data. For example, the power inlet monitoring device 800 may include GPS location capability and location data may be linked to the sensed power data. In other embodiments, the user device 90 may include GPS location capability, and location data may be referenced and recorded when the power inlet monitoring device 800 is plugged into the external power 33. The power data may be obtained and stored while the power inlet monitoring device 800 may be connected to a certain or particular external power 33 which may be linked to the location data. Such data may be stored on the user device 90, on one or more of the databases 104 of the remote computer network 102, and/or on the power inlet monitoring device 800. In some embodiments, a GPS location may be correlated to the location of a particular recreational vehicle park. The power inlet monitoring device 800 may, therefore, keep a memory of the quality of a power supply at a given park. Such data may be associated with a time stamp indicating a time and date of use. In some embodiments, such data may be combined with data obtained from the power inlet monitoring device 800 connected to the same web-based service to create a cloud-based database cataloging users' actual experience with the power supply of a particular recreational vehicle park.

The web-based service may maintain the computer system 102 having one or more of the databases 104 that may store data and analysis results generated by one or more recreational vehicle power monitoring and the reporting devices 20 and may also perform calculations based on the stored data and analysis results.

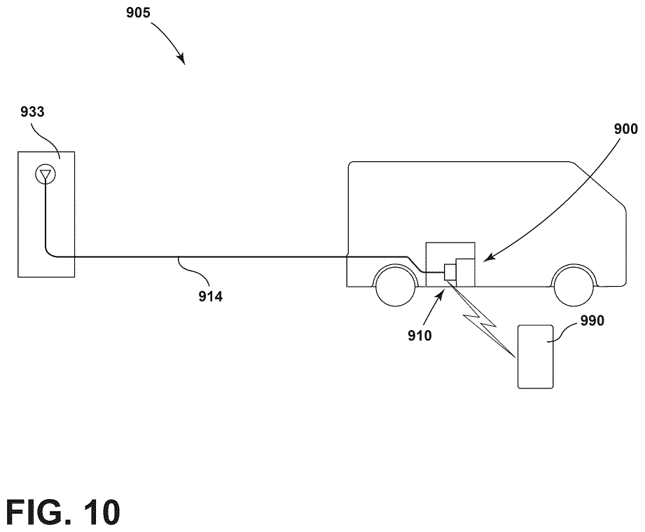

FIG. 10 is a schematic view of one embodiment of a power inlet monitoring device 900 used in a recreational vehicle utilized within a remote reporting 905 that may include an external power source or supply 933, a power line 914, a power inlet monitoring device 900, a communication module 910, and a remote device 990. In some embodiments, the connection between the power inlet monitoring device 900 and the user device 990 may comprise a remote connection such that the communication module 910 may send information to the remote device 990 wirelessly.

In some instances, power sources may be unstable, inconsistent, dangerous, or of low quality. Such external power sources may have a negative effect on aspects of a vehicle's electrical system. Accordingly, in some embodiments, the power inlet monitoring device 900 may enable real-time monitoring of power performance data and may also provide notifications to the user device 990 when aspects of the external power 933 fall out of acceptable ranges and produce a dangerous condition. As such, a user associated with the user device 990 may be alerted to address external power source problems before harm or damage may be done to a person or a vehicle's electrical system.

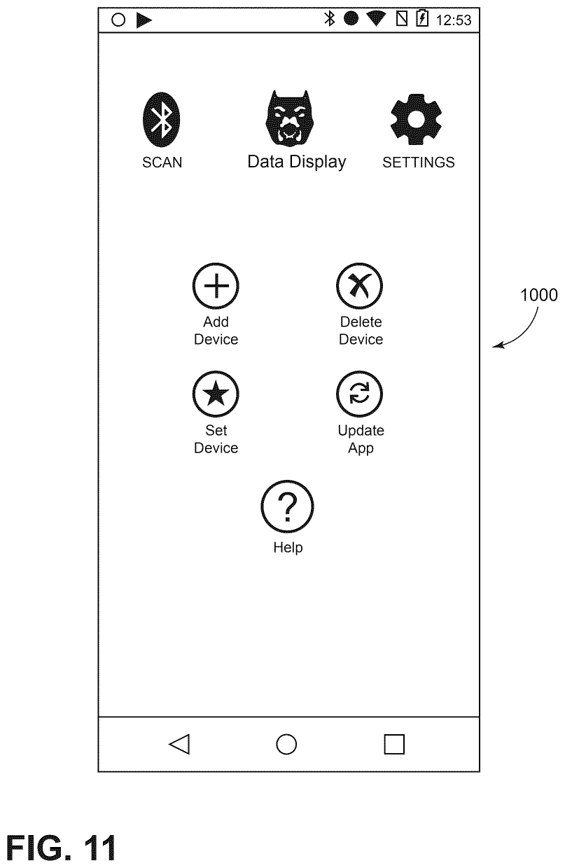

FIG. 11 is an illustration showing an installation interface screen of a remote user device associated with a power inlet monitoring device. In the illustrated example, a home screen 1000 associated with a remote user device, such as the remote device 990 (FIG. 9). The remote device 990 may be associated with a power inlet monitoring device 900 such that the remote device 990 may send and receive electrical performance and related data from the power inlet monitoring device 905.

In some embodiments, the communication module 910 may comprise a Bluetooth communications module. A user device such as remote device 990 of FIG. 9 may be adapted to receive and send Bluetooth, Wi-Fi, or near-field communications (“NFC”), and a power inlet monitoring device may therefore communicate electrical performance data to the remote device 990 via the communication module 910. In some embodiments, the remote device 990 may comprise a smartphone and the communication module 910 of the power inlet monitoring device 900 may be configured on the screen 1000.

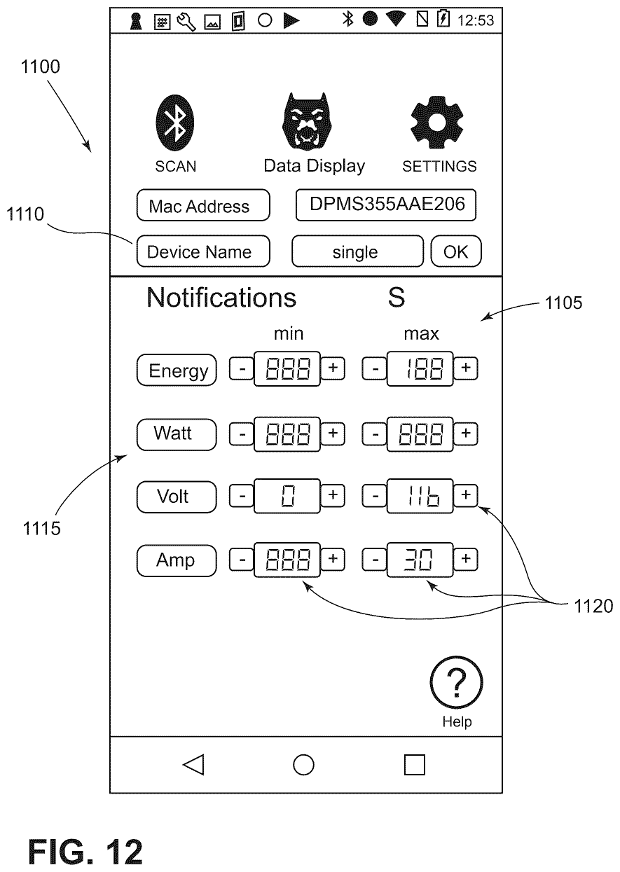

FIG. 12 is an illustration showing a notification setup screen of a remote user device associated with a power inlet monitoring device. A notification setup screen 1100 may comprise a device name 1110, a tolerance setup screen 1105, and one or more parameters 1115. In one embodiment, the notification setup screen 1100 may receive input to set tolerances to the one or more parameters 1115 of electrical characteristics. In some embodiments, the notification setup screen 1100 may comprise “min” and “max” parameter boxes 1120 for a user to enter acceptable minimum and maximum threshold values for the electrical parameter tolerances such as energy, watts, volts, and amperage. These minimum and maximum threshold values may be measured and set for a given period of time.

| In some embodiments, if there is no set minimum or maximum setting for a particular aspect power, the notification setup screen 1100 may not determine whether that particular aspect falls out of any range. For example, not all min and max parameter boxes 1120 require an associated input. Similarly, a user associated with the notification setup screen 1100 may provide data for both minimum and maximum values, for only one or minimum and maximum value, or for neither minimum nor maximum value. In some embodiments, the notification setup screen 1100 may have a given default value that may be used as the minimum or maximum value unless and until changed.

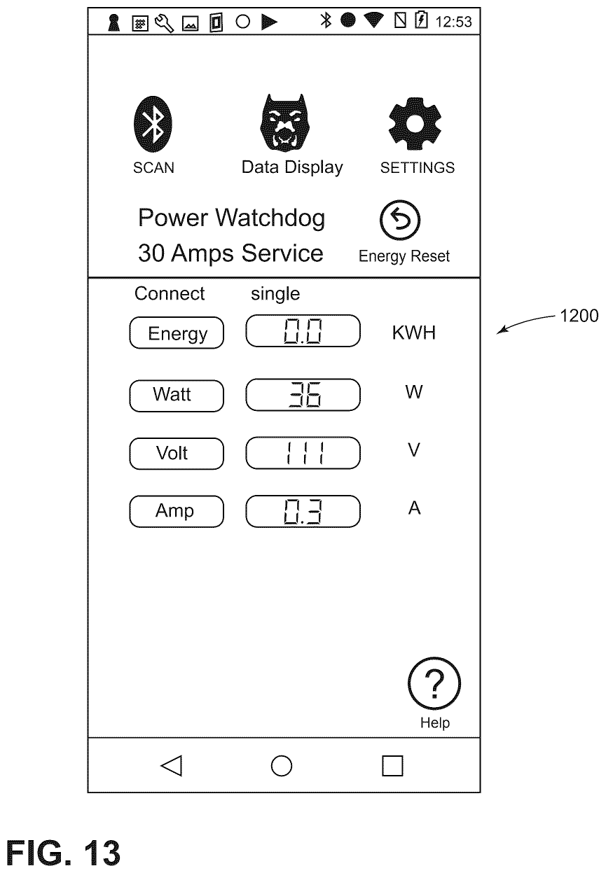

FIG. 13 is an illustration showing a 30 AMP data screen of a remote user device associated with a power inlet monitoring device. The 30 AMP model screen 1200 may be a remote device screen display that provides information relating to an electrical parameter of a power inlet monitoring device that may be stored on the remote device and retrieved at a later time. In some embodiments, the information relating to electrical power may allow the user to review a history of power conditions, including alerts generated due to unideal power conditions. In some embodiments, the information may be displayed in the form of a graph over time. In some embodiments, this functionality may be used to monitor how much power the user has used at any particular location or campground. This information may be compiled from multiple users to create a database that identifies the type of power offered by recreational vehicle parks. The recreational vehicle park managers may also have access to this database

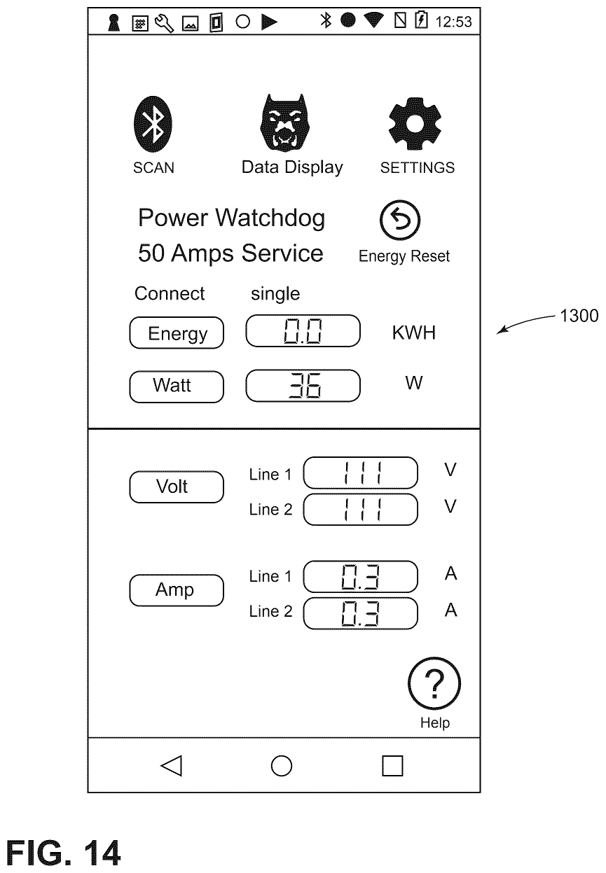

FIG. 14 is an illustration showing a 50 AMP data screen of a remote user device associated with a power inlet monitoring device. The 50 AMP model screen 1300 may be a remote device screen display that provides information relating to an electrical parameter of a power inlet monitoring device that may be stored on the remote device and retrieved at a later time. In some embodiments, the information relating to electrical power may allow the user to review a history of power conditions, including alerts generated as a result of unideal power conditions. In some embodiments, the information may be displayed in the form of a graph over time. In some embodiments, this functionality may be used to monitor how much power the user has used at any particular location or campground. This information may be compiled from multiple users to create a database that identifies the type of power offered by recreational vehicle parks. The recreational vehicle park managers may also have access to this database

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods may be described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

In the foregoing description, it will be readily appreciated by those skilled in the art that modifications may be made to the disclosed invention without departing from the concepts disclosed herein. Such modifications are to considered as included in the following claims, unless these claims by their language expressly statewide otherwise.

What is claimed is:

1. A power inlet protection and monitoring device for a recreational vehicle, comprising:
an electrical input port configured to be coupled to an electrical power source via at least one positive wire, a neutral wire and a ground wire;
an electrical output connection configured to transmit electrical power to the recreational vehicle;
a surge protector electrically coupled to the electrical input port and to the electrical output connection; and
a power monitor including at least one sensor, wherein the power monitor is configured to receive information gathered by the at least one sensor, wherein the information includes the status of a voltage carried on the ground wire;
wherein power monitoring and reporting device is configured to cut off an electrical connection between the electrical input port and the electrical output connection based on the status of the voltage carried on the ground wire to prevent a damaging electrical event in the recreational vehicle; and
wherein the power inlet protection and monitoring device is configured to communicate power data to a user based on the information.

2. The power inlet protection and monitoring device of claim 1, further comprising:
a visual indicator configured to communicate the power data to the user.

3. The power inlet protection and monitoring device of claim 2, wherein the visual indicator includes an indicator light.

4. The power inlet protection and monitoring device of claim 3, wherein the indicator light is configured to communicate a first status of the information via first color and a second status of the information via a second color that is different than the first color.

5. The power inlet protection and monitoring device of claim 1, wherein the power inlet protection and monitoring device is configured to communicate the power data to remote wireless device.

6. The power inlet protection and monitoring device of claim 5, wherein the wireless device includes a cell phone.

7. The power inlet protection and monitoring device of claim 6, wherein a configuration of the power inlet protection and monitoring device is configured to the controlled via the remote wireless device.

8. The power inlet protection and monitoring device of claim 1, further comprising:
a housing that houses the surge protect and the power monitor.

9. The power inlet protection and monitoring device of claim 8, wherein the housing is at least partially external to the recreational vehicle.

10. The power inlet protection and monitoring device of claim 9, wherein the housing is attached to the recreational vehicle.

11. The power inlet protection and monitoring device of claim 1, wherein the information received from the at least one sensor further includes at least one of frequency, amperage, open ground and neutral status.

12. The power inlet protection and monitoring device of claim 1, wherein cutting off the electrical connection between the electrical input port and the electrical output port includes completely electrically isolating the recreational vehicle from the electrical power source.

13. A method for protecting and monitoring the status of recreational vehicle power to a recreational vehicle, comprising:
providing the recreational vehicle power monitoring and reporting device of claim 1;
electrically coupling the electrical output connection to the recreational vehicle;
electrically coupling the electrical input port to the electrical power source;
receiving the information from the at least one sensor and generating the power data via the power monitor; and
cutting off the electrical connection between the electrical input port and the electrical output connection based on the information.

14. A power inlet protection and monitoring device for a recreational vehicle, comprising:
an electrical input port configured to be coupled to an external power source via at least one voltage line, a neutral line and a ground line, wherein the electrical input port has electrical characteristics when accepting power from an external power source;
an electrical output connection configured to transmit electrical power to the recreational vehicle;
a power monitor configured to measure electrical characteristics of the electrical output connection and configured to determine whether the electrical characteristics of the electrical output connection are in tolerance, wherein when the power monitor determines that the electrical characteristics of the electrical output connection are out of tolerance or a fault is present the monitoring module triggers one or more alarm conditions, wherein the power monitor comprises one or more sensors configured monitor for a positive voltage carried on the ground line and wherein the electrical characteristics measured by the power monitor includes the positive voltage carried on the ground line;
a power conditioner including a surge protector configured to redirect a surge in voltage and amperage, wherein when the power monitor triggers the alarm condition the power inlet protection and monitoring device cuts off the electrical connection of the ground line between the electrical input port and the electrical output connection; and
a communicator configured to transmit power data to a remote device based on the electrical characteristics measured by the power monitor.

15. The power inlet protection and monitoring device of claim 14, wherein the remote device includes a wireless device.

16. The power inlet protection and monitoring device of claim 15, wherein the wireless device includes a cell phone.

17. The power inlet protection and monitoring device of claim 16, wherein a configuration of the power inlet protection and monitoring device is configured to the controlled via the remote wireless device.

18. The power inlet protection and monitoring device of claim 14, further comprising:
a housing that houses the power monitor, the power conditioner and the communicator.

19. The power inlet protection and monitoring device of claim 18, wherein the housing is at least partially external to the recreational vehicle.

20. The power inlet protection and monitoring device of claim 19, wherein the housing is attached to the recreational vehicle.

21. The power inlet protection and monitoring device of claim 14, further comprising:
a visual indicator configured to communicate the power data to the user.

22. The power inlet protection and monitoring device of claim 21, wherein the visual indicator includes an indicator light.

23. The power inlet protection and monitoring device of claim 22, wherein the indicator light is configured to communicate a first status of the information via first color and a second status of the information via a second color that is different than the first color.

24. The power inlet protection and monitoring device of claim 14, wherein the information received from the at least one sensor further includes at least one of frequency, amperage, open ground and neutral status.

25. The power inlet protection and monitoring device of claim 14, wherein cutting off the electrical connection between the electrical input port and the electrical output port includes completely electrically isolating the recreational vehicle from the electrical power source.

26. A method for protecting and monitoring the status of recreational vehicle power to a recreational vehicle, comprising:
providing the recreational vehicle power monitoring and reporting device of claim 14;
electrically coupling the electrical output connection to the recreational vehicle;
electrically coupling the electrical input port to the electrical power source;
receiving the information from the at least one sensor and generating the power data via the power monitor; and
cutting off the electrical connection between the electrical input port and the electrical output connection based on the information.
